(19) United States
(12) Patent Application Publication
(10) Pub. No.: US 2025/0375030 A1
(43) Pub. Date: Dec. 11, 2025

(54) PORTABLE WORKSTATION ASSEMBLY AND METHODS OF USING THE SAME

(71) Applicant: John Hadden, Dalton, GA (US)

(72) Inventor: John Hadden, Dalton, GA (US)

(21) Appl. No.: 18/734,652

(22) Filed: Jun. 5, 2024

(51) Int. Cl. A47B 37/04; B60D 1/58

(52) U.S. Cl. CPC A47B 37/04; B60D 1/58

(57) ABSTRACT

Various embodiments are directed to portable workstation assemblies and methods of manufacturing the same. In various embodiments, the portable workstation assembly comprises a T-bar frame configured for selective attachment relative to an anchor point of a vehicle and comprising an attachment arm, a crossbar arranged in a perpendicular configuration relative to the attachment arm; and a plurality of workstation posts extending from the crossbar in a perpendicular direction relative to the central axis of the crossbar, each of the plurality of workstation posts extending from a respective location defined along a length of the crossbar; and a plurality of detachable workstations configured for selective attachment to a respective one of the plurality of workstation posts, each detachable workstation comprising a planar workstation base, a plurality of attachment apertures, and a workstation coupling element configured to facilitate a detachable arrangement of each detachable workstation base relative to the respective workstation post.

### FIELD OF THE INVENTION

Various embodiments described herein relate generally to portable workstation assemblies configured for attachment to a vehicle tow hitch and having a selectively configurable workstation arrangement wherein one or more of a plurality of detachable workstations may be selectively attached to a T-bar frame to define a respective plurality of mobile workstations that are each specifically configured for facilitating execution of a respective tool-based building and/or assembly operation by a user.

### BACKGROUND

Applicant has identified many technical challenges and difficulties associated with workstation assemblies being unable to effectively accommodate a variety of different usage cases in an on-demand manner at various distinct locations. Through applied effort, ingenuity, and innovation, Applicant has solved problems related to these wearable accessory arm straps by developing solutions embodied in the present disclosure, which are described in detail below.

### BRIEF SUMMARY

Various embodiments are directed to a portable workstation assembly and methods of using the same. In various embodiments, a portable workstation assembly may comprise a T-bar frame configured for selective attachment relative to an anchor point of a vehicle, the T-bar frame comprising: an attachment arm; a crossbar having crossbar length defined along a central axis thereof in between a first crossbar end and a second crossbar end, the crossbar being arranged in an at least substantially perpendicular configuration relative to an arm length defined by an attachment arm central axis of the attachment arm; and a plurality of workstation posts extending from the crossbar in an at least substantially perpendicular direction relative to the central axis of the crossbar, each of the plurality of workstation posts extending from a first post end disposed at a respective location defined along the crossbar length of the crossbar; and a plurality of detachable workstations, each of the detachable workstations being configured for selective attachment to a respective workstation post of the plurality of workstation posts defined by the T-bar frame, each of the plurality of detachable workstations comprising: a planar workstation base; a plurality of attachment apertures extending through a base thickness of the planar workstation base; and a workstation coupling element attached to the planar workstation base and configured for engagement with at least a portion of the respective workstation post to facilitate a detachable arrangement of the planar workstation base relative to the respective workstation post.

In various embodiments, each of the workstation posts may define a post length extending along a central axis thereof between the first post end engaged with the crossbar and a second post end, wherein each of the respective workstation posts of the plurality of workstation posts is configured for engagement with one or more of the plurality of detachable workstations at the second post end thereof. In various embodiments, each of the respective workstation posts of the plurality of workstation posts may be configured such that the respective second post ends of the plurality of workstation posts each engage the one or more detachable workstations at the respective workstation coupling element thereof. In various embodiments, each of the workstation coupling elements of the plurality of detachable workstations may comprise a workstation pin aperture.

In various embodiments, the plurality of detachable workstations may comprise a first detachable workstation and a second detachable workstation. In certain embodiments, the first detachable workstation may comprise a first planar workstation base defining a first base top surface having a first surface area and the second detachable workstation comprises a second planar workstation base defining a second base top surface having a second surface area, wherein the first surface area is different from the second surface area. In certain embodiments, the first detachable workstation may comprise a first planar workstation base defining a first base thickness and the second detachable workstation comprises a second planar workstation base defining a second base thickness, wherein the first base thickness is different than the second base thickness. In certain embodiments, each of the plurality of detachable workstations may be defined by an at least partially unique configuration wherein one or more workstation characteristic of each detachable workstation is unique relative to the workstation characteristics defined by the other detachable workstations of the plurality of detachable workstations. In certain embodiments, the plurality of detachable workstations may comprise three or more detachable workstations.

In various embodiments, the plurality of workstation posts of the T-bar frame may comprise a first workstation post and a second workstation post. In certain embodiments, the first workstation post may extend from the crossbar at a first location along the crossbar length of the crossbar and the second workstation post extends from the crossbar at a second location along the crossbar length of the crossbar, wherein the first location is at least substantially adjacent the first crossbar end and the second location is at least substantially adjacent the second crossbar end. In certain embodiments, the plurality of workstation posts may comprise three or more workstation posts. In various embodiments, each of the plurality of workstation posts may be oriented in an at least substantially parallel configuration relative to one another. In certain embodiments, the plurality of workstation posts may be oriented in an at least substantially coplanar configuration.

In various embodiments, the T-bar frame may be configured to attach to the anchor point of the vehicle based at least in part on a fastening element defined at least substantially adjacent a first arm end of the attachment arm. In certain embodiments, the fastening element may comprise a hitch pin aperture. In various embodiments, the plurality of attachment apertures of each of the plurality of detachable workstations may comprise at least four attachment apertures distributed about the respective planar workstation bases of each detachable workstation. In certain embodiments, the plurality of attachment apertures of each of the plurality of detachable workstations may be distributed about the respective planar workstation bases of each detachable workstation in a symmetric arrangement. In various embodiments, the attachment arm, the crossbar, and the plurality of workstation posts may collectively define a unitary configuration such that the T-bar frame is defined by a singular frame component.

### BRIEF DESCRIPTION OF THE DRAWINGS

Reference will now be made to the accompanying drawings, which are not necessarily drawn to scale, and wherein:

FIG. 1 illustrates a perspective view of a portable workstation assembly in accordance with one or more example embodiments described herein;

FIGS. 2A-2C illustrate various perspective views of a workstation frame of a portable workstation assembly in accordance with an example embodiment described herein;

FIGS. 3A and 3B illustrate a top perspective view and a front perspective view, respectively, of a removeable base station of a portable workstation assembly in accordance with an example embodiment described herein; and

FIG. 4 illustrates an exploded view of a portable workstation assembly in accordance with one or more example embodiments described herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

It should be understood at the outset that although illustrative implementations of one or more aspects are illustrated below, the disclosed assemblies, systems, and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements are disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

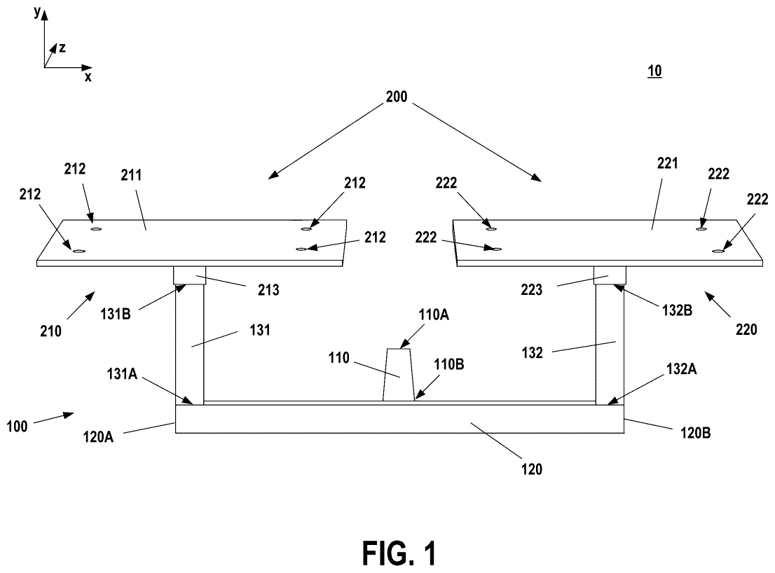

FIG. 1 illustrates a perspective view of a portable workstation assembly in accordance with one or more example embodiments described herein. In particular, FIG. 1 illustrates an example portable workstation assembly 10 comprising a T-bar frame 100 and a plurality of detachable workstations 200 configured to be selectively and detachably secured to respective portions of the T-bar frame 100 to define a plurality of workstations each configured for securing and/or engaging one or more tools relative thereto to facilitate efficient and effective user engagement with the one or more tools at the respective workstations. In various embodiments, the T-bar frame 100 of an example portable workstation assembly 10 may be configured for selective attachment relative to an anchor point of a vehicle, such as, for example, a tow hitch, a tow bar, and/or a trailer hitch provided at a rear end of a truck, other vehicle, and/or the like. For example, the portable workstation assembly 10 may be configured such that one or more of a plurality of detachable workstations 200 may be selectively secured relative to a respective portion of the T-bar frame 100 to define one or more workstation specifically configured to facilitate an execution particular tool-based operation desired by a user at a location at least substantially near the rear end of a vehicle (e.g., a truck bed).

As illustrated, in various embodiments, a portable workstation assembly 10 may comprise a T-bar frame 100 comprising an attachment arm 110, a crossbar 120, and a plurality of workstation posts 130. In various embodiments, an attachment arm 110 of the T-bar frame 100 of an example portable workstation assembly 10 may comprise an at least substantially rigid linear element, such as, for example, a rod, a pole, and/or the like. For example, in various embodiments, the attachment arm 110 may be made of an at least substantially rigid material, such as, for example, a steel material, an aluminum alloy material, any metal alloy material, a plastic material, any combination thereof, and/or the like. The attachment arm 110 may have an arm length that is defined along a central axis thereof in between a first arm end 110A and a second arm end 110B. For example, in the exemplary embodiment illustrated in FIG. 1, the central axis of the attachment arm 110 extends in a longitudinal direction at least substantially parallel with the z-axis, as defined in the exemplary embodiment.

In various embodiments, the attachment arm 110 may have a cross-sectional shape corresponding to the at least a portion of the tow hitch with which the first arm end 110A thereof is configured to engage, such as, for example, a square cross-sectional shape, a rounded cross-sectional shape, and/or any other operable shape configured to facilitate the selective coupling operation described herein. As a non-limiting example embodiment described for illustrative purposes, in some embodiments, the attachment arm 110 may be made of 2-inch steel tube having a square cross-sectional shape (e.g., a steel tube having a 2-inch cross-sectional width and height).

The attachment arm 110 may be configured for selective attachment to a corresponding portion of a tow hitch provided at a rear of a vehicle (e.g., a truck) to secure the T-bar frame 100 to the tow hitch (e.g., in a secure position relative to the rear of the vehicle). For example, the attachment arm 110 may include a hitch coupling element disposed at the first arm end 110A thereof that is configured to receive and/or otherwise engage the tow hitch to facilitate a secure coupling of the portable workstation assembly 10 to a vehicle. Further, as illustrated, the attachment arm 110 may be at least substantially rigidly attached (e.g., permanently) to the crossbar 120 at the second arm end 110B thereof. For example, the second arm end 110B may abut against a surface of the crossbar 120 (e.g., a side surface) to define an at least substantially permanent interface between the second arm end 110B and the crossbar 120 at a location along the length of the crossbar 120, such as, for example, at a midpoint location along the length of the crossbar 120. In various embodiments the attachment arm 110 (e.g., the second arm end 110B) may either be integral with the crossbar 120 so as to define a singular piece of material or, alternatively and/or additionally, may be at least semi-permanently attached to the crossbar 120 (e.g., via a welding process and/or the like).

In various embodiments, a crossbar 120 of the T-bar frame 100 of an example portable workstation assembly 10 may comprise an at least substantially rigid linear element, such as, for example, a rod, a pole, and/or the like. For example, in various embodiments, the crossbar 120 may be made of an at least substantially rigid material, such as, for example, a steel material, an aluminum alloy material, any metal alloy material, a plastic material, any combination thereof, and/or the like. The crossbar 120 may have a crossbar length that is defined along a central axis thereof in between a first crossbar end 120A and a second crossbar end 120B. For example, in the exemplary embodiment illustrated in FIG. 1, the central axis of the crossbar 120 extends in a lateral direction at least substantially parallel with the x-axis, as defined in the exemplary embodiment.

In various embodiments, the T-bar frame 100 may be configured such that the crossbar 120 rigidly secured to the second arm end 110B end is arranged in an at least substantially perpendicular configuration relative to the attachment arm 110. For example, the T-bar frame 100 may be configured such that the arm length defined by the attachment arm 110 and the crossbar length defined by the crossbar 120 are oriented in respective directions that are at least substantially perpendicular to one another. As illustrated, the arm length of the attachment arm 110 may be oriented in the longitudinal direction (e.g., along the z-axis as defined in the exemplary embodiment illustrated in FIG. 1) and the crossbar length of the crossbar 120 may be oriented in the lateral direction perpendicular thereto (e.g., along the x-axis as defined in the exemplary embodiment illustrated in FIG. 1). In various embodiments, the attachment arm 110 and the crossbar 120 arranged perpendicular thereto may be configured in an at least substantially coplanar arrangement, wherein the perpendicular arm length and crossbar length of the attachment arm 110 and the crossbar 120, respectively, are defined within the same plane. As a non-limiting example, the attachment arm 110 and the crossbar 120 may collectively define a “T”-shaped portion of the T-bar frame 100. For example, as illustrated, the attachment arm 110 and the crossbar 120 may each be arranged within at least substantially the same horizontal plane (e.g., within the x-z plane, as defined in the exemplary embodiment illustrated in FIG. 1). In various embodiments, the T-bar frame 100 may be configured such that the at least substantially horizontal plane within which the attachment arm 110 and the crossbar 120 are disposed may be at least substantially parallel with at least a portion of the ground surface upon which the vehicle secured to the T-bar frame 100 (e.g., at the first arm end 110A of the attachment arm 110) is located.

In various embodiments, the crossbar 120 may have either the same or different cross-sectional shape as the attachment arm 110, such as, for example, either a square cross-sectional shape, a rounded cross-sectional shape, and/or any other operable shape configured to facilitate the engagement of the crossbar 120 to the attachment arm 110 described herein. As a non-limiting example embodiment described for illustrative purposes, in some embodiments, the crossbar 120 may be made of 2-inch steel tube having a square cross-sectional shape (e.g., a steel tube having a 2-inch cross-sectional width and height).

In various embodiments, the T-bar frame 100 of an example portable workstation assembly 10 may further comprise a plurality of workstation posts 130 each configured to extend from a respective location along the crossbar length of the crossbar 120 in a vertical direction and facilitate the detachable coupling of one or more detachable workstations of the portable workstation assembly 10 relative to the T-bar frame 100. In various embodiments, each of the plurality of workstation posts 130 of the T-bar frame 100 of an example portable workstation assembly 10 may comprise an at least substantially rigid linear element, such as, for example, a rod, a pole, and/or the like. For example, in various embodiments, each of the plurality of workstation posts 130 may be made of an at least substantially rigid material, such as, for example, a steel material, an aluminum alloy material, any metal alloy material, a plastic material, any combination thereof, and/or the like. Each workstation post 130 may have a respective post length that is defined along a central axis of the respective workstation post 130 in between a first post end and a second post end thereof. For example, in the exemplary embodiment illustrated in FIG. 1, the plurality of workstation posts 130 comprises a first workstation post 131 extending along a first post central axis between a first post end 131A and second post end 131B thereof, and a second workstation post 132 extending along a second post central axis (e.g., at least substantially parallel to the first post central axis) between a first post end 132A and second post end 132B thereof. The first and second workstation posts 131, 132 may be configured such that the first and second post central axes thereof, respectively, are each oriented in a vertical direction at least substantially parallel with the y-axis (e.g., in a positive y-direction as defined in the exemplary embodiment illustrated in FIG. 1).

In various embodiments, the plurality of workstation posts 130 may be at least substantially rigidly attached (e.g., permanently) to the crossbar 120 at a respective location along the crossbar length thereof. For example, in an exemplary embodiment wherein the plurality of workstations posts 130 comprises a first workstation post 131 and a second workstation post 132, as illustrated in the example embodiment of FIG. 1, the first workstation post 131 may be at least substantially permanently secured to the crossbar 120 (e.g., a top surface of the crossbar 120) at a first location at least substantially adjacent the first crossbar end 120A of the crossbar 120 and the second workstation post 132 may be at least substantially permanently secured to the crossbar 120 (e.g., a top surface of the crossbar 120) at a second location at least substantially adjacent the second crossbar end 120B of the crossbar 120. In various embodiments, the first workstation post 131 (e.g., the first post end 131A thereof) may either be integral with the crossbar 120 so as to define a singular piece of material or, alternatively and/or additionally, may be at least semi-permanently attached to the crossbar 120 (e.g., via a welding process and/or the like). For example, the first workstation post 131 may be attached to the crossbar 120 so as to define an at least substantially permanent interface between the first post end 131A thereof and the crossbar 120 at a location at least substantially adjacent the first crossbar end 120A of the crossbar 120. Further, in various embodiments, the second workstation post 132 (e.g., the first post end 132A thereof) may either be integral with the crossbar 120 so as to define a singular piece of material or, alternatively and/or additionally, may be at least semi-permanently attached to the crossbar 120 (e.g., via a welding process and/or the like). For example, the second workstation post 132 may be attached to the crossbar 120 so as to define an at least substantially permanent interface between the first post end 132A thereof and the crossbar 120 at a location at least substantially adjacent the second crossbar end 120B of the crossbar 120.

In various embodiments, the plurality of workstation posts 130 may be configured such that each of the workstation posts having a first post end secured to the crossbar 120 (e.g., the first post end 131A of the first workstation post 131 and the first post end 132A of the second workstation post 132) is arranged in an at least substantially perpendicular configuration relative to the crossbar 120. For example, the plurality of workstation posts 130 may be configured such that each of the post lengths defined by the respective workstation posts of the plurality 130 is oriented in an at least substantially perpendicular configuration relative to the crossbar length defined by the crossbar 120. As illustrated, the post length of each of the plurality of workstation posts 130 may be oriented in the vertical direction (e.g., in a positive y-direction along the y-axis as defined in the exemplary embodiment illustrated in FIG. 1) and the crossbar length of the crossbar 120 may be oriented in the lateral direction perpendicular thereto (e.g., along the x-axis as defined in the exemplary embodiment illustrated in FIG. 1).

In various embodiments, the each of the plurality of workstation posts 130 (e.g., the first and second workstation posts 131, 132) and the crossbar 120 arranged perpendicular thereto may be configured in an at least substantially coplanar arrangement, wherein the perpendicular post lengths and crossbar length of the plurality of workstation posts 130 and the crossbar 120, respectively, are defined within the same plane. As a non-limiting example, the first workstation post 131, the second workstation post 132, and the crossbar 120 may collectively define a “U”-shaped portion of the T-bar frame 100. For example, as illustrated, the plurality of workstation posts 130 and the crossbar 120 may each be arranged within at least substantially the same vertical plane (e.g., within the x-y plane, as defined in the exemplary embodiment illustrated in FIG. 1). In various embodiments, the T-bar frame 100 may be configured such that the at least substantially vertical plane within which the plurality of workstation posts 130 and the crossbar 120 are disposed may be at least substantially perpendicular to the at least substantially horizontal plane within which the attachment arm 110 and the crossbar 120 are disposed and/or the at least a portion of the ground surface upon which the vehicle secured to the T-bar frame 100 (e.g., at the first arm end 110A of the attachment arm 110) is located.

In various embodiments, each of the plurality of workstation posts 130 may be configured for selective attachment to a respective detachable workstation of the plurality of detachable workstations 200 of the example portable workstation assembly 10, as described herein, to secure the T-bar frame 100 to one or more of the plurality of detachable workstations 200. The plurality of workstation posts 130 may each be configured to receive and/or otherwise engage a respective detachable workstation of the plurality of detachable workstations 200 defined by the portable workstation assembly 10 at a respective distal post end thereof opposite the post end thereof interfaced with the crossbar 120. For example, as illustrated in FIG. 1, the first workstation post 131 may define a second post end 131B opposite the first post end 131A thereof (e.g., as defined along the first post length thereof) at which the first workstation post 131 is configured to receive and/or otherwise engage a first detachable workstation 210 of the portable workstation assembly 10 so as to detachably and rigidly secure the first detachable workstation 210 relative to the T-bar frame 100. Further, the second workstation post 132 may define a second post end 132B opposite the first post end 132A thereof (e.g., as defined along the second post length thereof) at which the second workstation post 132 is configured to receive and/or otherwise engage a second detachable workstation 220 of the portable workstation assembly 10 so as to detachably and rigidly secure the second detachable workstation 220 relative to the T-bar frame 100.

In various embodiments, each of the plurality of workstation posts 130 may have a cross-sectional shape corresponding to the at least a portion of a detachable workstation to which the second post end thereof (e.g., the second post end 131B of the first workstation post 131 and the second post end 132B of the second workstation post 132) is configured to be attached, such as, for example, a square cross-sectional shape, a rounded cross-sectional shape, and/or any other operable shape configured to facilitate the selective coupling operation described herein. As a non-limiting example embodiment described for illustrative purposes, in some embodiments, one or more of the plurality of workstation posts 130 (e.g., the first workstation post 131 and/or the second workstation post 132) may be made of 2-inch steel tube having a square cross-sectional shape (e.g., a steel tube having a 2-inch cross-sectional width and height).

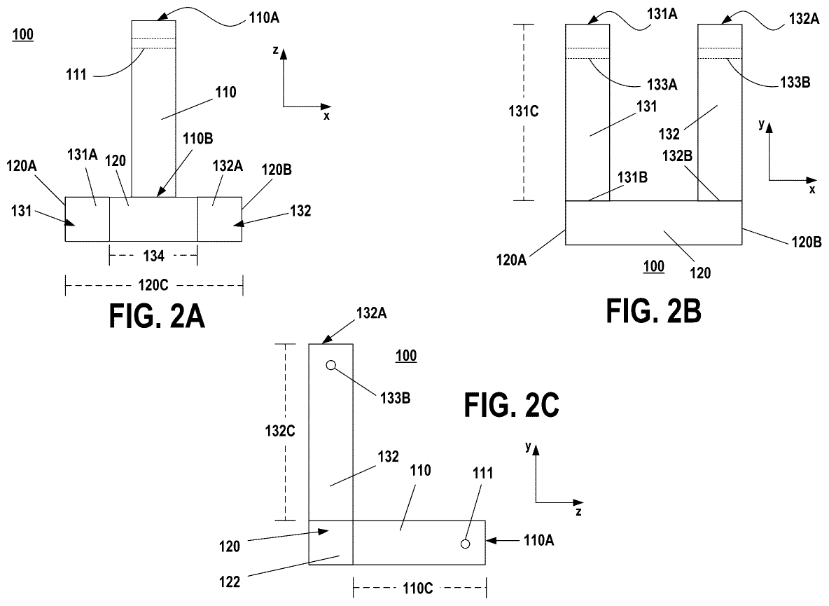

FIGS. 2A-2C illustrate various perspective views of a workstation frame of a portable workstation assembly in accordance with an example embodiment described herein. In particular, FIG. 2A, FIG. 2B, and FIG. 2C illustrate a top view, a front view, and a right-side view of a T-bar frame 100 of an example portable workstation assembly in accordance with one or more embodiments of the present disclosure. As illustrated in FIG. 2A, the crossbar 120 of an example T-bar frame 100 may have a crossbar length defined between the first crossbar end 120A and the second crossbar end 120B of the crossbar 120. In various embodiments, the crossbar length 120C defined by an example crossbar 120 may be at least approximately between 12 inches and 24 inches (e.g., 18 inches). For example, in such an exemplary configuration, the T-bar frame 100 may be configured such that a lateral post separation gap 134 defined by the lateral distance between closest-most surfaces of the first and second workstation posts 131, 132 of the plurality of workstation posts 130, as measured in a lateral direction (e.g., in the x-direction as defined by the example embodiment illustrated in FIG. 2A) may be at least approximately between 8 inches and 20 inches (e.g., 14 inches).

As illustrated in FIG. 2B, in various embodiments, the first workstation post 131 of the plurality of workstation posts 130 of an example T-bar frame 100 may have a first post length 131C defined between the first post end 131A and the second post end 131B of the first workstation post 131. In various embodiments, the first post length 131C defined by an example first workstation post 131 may be at least approximately between 12 inches and 24 inches (e.g., 18 inches).

Further, as illustrated in FIG. 2C, in various embodiments, the second workstation post 132 of the plurality of workstation posts 130 of an example T-bar frame 100 may have a second post length 132C defined between the first post end 132A and the second post end 132B of the second workstation post 132. In various embodiments, the second post length 132C defined by an example second workstation post 132 may be at least approximately between 12 inches and 24 inches (e.g., 18 inches). In various embodiments, the attachment arm 110 of an example T-bar frame 100 may have an arm length 110C defined between the first arm end 110A and the second arm end 110B of the attachment arm 110. In various embodiments, the arm length 110C defined by an example attachment arm 110 may be at least approximately between 12 inches and 24 inches (e.g., 18 inches).

In various embodiments, as further illustrated in FIG. 2B, the crossbar 120 of an example T-bar frame 100 may have a crossbar length defined between the first crossbar end 120A and the second crossbar end 120B of the crossbar 120. In various embodiments, the crossbar length 120C defined by an example crossbar 120 may be at least approximately between 12 inches and 24 inches (e.g., 18 inches).

In various embodiments, the attachment arm 110 of the exemplary T-bar frame 100 may comprise one or more coupling features configured to facilitate a selective engagement with a corresponding portion of a tow hitch defined by a vehicle to selectively couple the portable workstation assembly (e.g., the T-bar frame 100) in a secured configuration relative to the tow hitch. As a non-limiting example illustrated in FIGS. 2A and 2C, the attachment arm 110 may comprise a hitch pin aperture 111 defined by an at least substantially tubular channel extending along an interior portion of the attachment arm 110 in a lateral direction at least substantially perpendicular to the arm length thereof (e.g., in an x-direction as defined in the example embodiment illustrated in FIG. 2A). In various embodiments, the hitch pin aperture 111 may be disposed along a width of the attachment arm 110 defined at a location along the arm length thereof that is at least substantially adjacent the first arm end 110A of the attachment arm 110.

For example, in an exemplary embodiment wherein the T-bar frame 100 is configured for attachment to a tow hitch having a coupling mechanism defined by a corresponding hitch pin aperture, the hitch pin aperture 111 of the attachment arm 110 may be configured such that upon the attachment arm 110 being positioned relative to the tow hitch in an arrangement wherein hitch pin aperture 111 is at least substantially coaxially aligned with the corresponding hitch pin aperture of the tow hitch, the hitch pin aperture 111 may be configured to receive a fastening mechanism (e.g., a hitch pin, a cotter pin, a carabiner, and/or the like) therethrough. For example, the attachment arm 110 may be configured such that upon being positioned relative to the tow hitch such that the fastening mechanism (e.g., a hitch pin) extending through the hitch pin aperture 111 physically engages both the hitch pin aperture 111 and the corresponding hitch pin aperture defined by the tow hitch, the fastening mechanism may function to secure the T-bar frame 100 relative to the tow hitch by at least substantially restricting the range of motion of the attachment arm 110 relative to tow hitch, thereby preventing the T-bar frame 100 from disengaging and/or detaching from the tow hitch.

In various embodiments, each of the plurality of workstation posts 130 of the exemplary T-bar frame 100 may comprise one or more coupling features configured to facilitate a selective engagement with one or more of the detachable workstation of the plurality of detachable workstations defined by an example portable workstation assembly to selectively couple the detachable workstation in a secured configuration relative to the T-bar frame 100. As a non-limiting example illustrated in FIG. 2B, the first workstation post 131 may comprise a first workstation pin aperture 133A defined by an at least substantially tubular channel extending along an interior portion of the first workstation post 131 in a lateral direction at least substantially perpendicular to the post length thereof (e.g., in an x-direction as defined in the example embodiment illustrated in FIG. 2B). In various embodiments, the first workstation pin aperture 133A may be provided along a width of the first workstation port 131 defined at a location along the post length thereof that is at least substantially adjacent the second post end 131B (e.g., the distal post end) of the first workstation port 131. Further, as illustrated, the second workstation post 132 may comprise a second workstation pin aperture 133B defined by an at least substantially tubular channel extending along an interior portion of the second workstation post 132 in a lateral direction at least substantially perpendicular to the post length thereof (e.g., in an x-direction as defined in the example embodiment illustrated in FIG. 2B). In various embodiments, the second workstation pin aperture 133B may be provided along a width of the second workstation post 132 defined at a location along the post length thereof that is at least substantially adjacent the second post end 132B (e.g., the distal post end) of the second workstation post 132.

For example, in an exemplary embodiment wherein the T-bar frame 100 is configured for attachment to an example detachable workstation having a coupling mechanism defined by a corresponding workstation pin aperture, the first and second workstation pin apertures 133A, 133B of the first and second workstation post 131, 132, respectively, may each be configured such that upon the respective workstation post 131, 132 being positioned relative to the workstation coupling element of a corresponding detachable workstation in an arrangement wherein the first and second workstation pin apertures 133A, 133B are at least substantially coaxially aligned with the corresponding workstation pin apertures of the respective detachable workstations, each workstation pin aperture 133A, 133B may be configured to receive a respective fastening mechanism (e.g., a hitch pin, a cotter pin, a carabiner, and/or the like) therethrough. For example, the first workstation post 131 may be configured such that upon being positioned relative to a first detachable workstation (e.g., a first workstation coupling element thereof) such that the fastening mechanism (e.g., a hitch pin) extending through the first workstation pin aperture 133A physically engages both the first workstation pin aperture 133A and the corresponding workstation pin aperture defined by the first detachable workstation, the fastening mechanism may function to secure the first detachable workstation relative to the T-bar frame 100 by at least substantially restricting the range of motion of the first detachable workstation relative to first workstation post 131, thereby preventing the first detachable workstation from disengaging and/or detaching from the T-bar frame 100. As a further example, the second workstation post 132 may be configured such that upon being positioned relative to a second detachable workstation (e.g., a second workstation coupling element thereof) such that the fastening mechanism (e.g., a hitch pin) extending through the second workstation pin aperture 133B physically engages both the second workstation pin aperture 133B and the corresponding workstation pin aperture defined by the second detachable workstation, the fastening mechanism may function to secure the second detachable workstation relative to the T-bar frame 100 by at least substantially restricting the range of motion of the second detachable workstation relative to second workstation post 132, thereby preventing the first detachable workstation from disengaging and/or detaching from the T-bar frame 100.

With reference back to the example embodiment illustrated in FIG. 1, in various embodiments, a portable workstation assembly 10 may comprise a plurality of detachable workstations 200 configured for selective attachment relative to a respective workstation post defined by the T-bar frame 100. As described herein, in various embodiments, the plurality of detachable workstations 200 may comprise a first detachable workstation 210 and a second detachable workstation 220 configured to be secured relative to a respective one of the plurality of workstation posts 130 of the T-bar frame 100. For example, the first detachable workstation 210 may be configured for selective attachment relative to the second post end 131B of the first workstation post 131 and the second detachable workstation 220 may be configured for selective attachment relative to the second post end 132B of the second workstation post 132 such that each of the plurality of detachable workstations 200 (e.g., the first detachable workstation 210 and the second detachable workstation 220) are disposed at respective vertical heights above the crossbar 120 of the T-bar frame 100 (e.g., relative to a ground surface, such as, for example, further in the positive y-direction as defined in the example embodiment illustrated in FIG. 1).

In various embodiments, an example detachable workstation of the plurality of detachable workstations 200 of the portable workstation assembly 10 may comprise a planar workstation base, a plurality of workstation apertures, and a workstation coupling element configured for selective engagement with a workstation post of the plurality 130 defined by the T-bar frame 100 to facilitate the secured attachment of the detachable workstation relative to the T-bar frame 100. As a non-limiting example, FIG. 1 illustrates a first detachable workstation 210 comprising a first planar workstation base 211, a first plurality of workstation apertures 212, and a first workstation coupling element 213. In various embodiments, the planar workstation base of an example detachable workstation of the plurality of detachable workstations 200, such as, for example, the first planar workstation base 211 of the first detachable workstation 210, may be defined at least in part by an at least substantially planar surface configured to support (e.g., physically support) one or more tools (e.g., a vice, an anvil, a miter saw, a band saw, and/or the like) provided thereon. As described in further detail herein, the planar workstation base of a detachable workstation (e.g., first planar workstation base 211 of the first detachable workstation 210, the second workstation base 221 of the second detachable workstation 220) may be defined at least in part by a top base surface and a bottom base surface, with a base thickness being defined along a vertical axis extending perpendicularly therebetween (e.g., in a z-direction, as defined by the example embodiment illustrated in FIG. 1). In various embodiments, an exemplary planar workstation base (e.g., first and/or second planar workstation bases 211, 221) may be made of a substantially rigid material such as, for example, a steel material, an aluminum alloy material, any metal alloy material, a plastic material, any combination thereof, and/or the like. As a non-limiting example, an exemplary planar workstation base may be made of 11-gauge steel.

In various embodiments, the first planar workstation base 211 and the second planar workstation base 221 may each be configured to facilitate the selective arrangement of one or more tools thereon and/or relative thereto in position(s) and/or configurations that are desirable to a user, such as, for example, by maximizing the ergonomics associated with a user's engagement with a tool disposed on the planar workstation base, stabilizing the positioning of the tool at the planar workstation base to increase tool performance (e.g., accuracy and/or precision) and decrease the risk of harm to a user by minimizing the movement of the tool during operation thereof, maximizing the accessibility of the entirety of the tool to a user by positioning a tool disposed on the planar workstation base (e.g., on the first planar workstation base 211 and/or on the second planar workstation base 221) in an elevated arrangement relative to a ground surface upon which an adjacent user is standing.

In various embodiments, each of the plurality of detachable workstations 200 may comprise a workstation coupling element arranged relative to a bottom surface of the planar workstation base of the detachable workstation and configured to receive and/or otherwise engage a workstation post of the T-bar frame 100 to facilitate the coupling of the detachable workstation to the T-bar frame 100. As illustrated, the first detachable workstation 210 may comprise a first workstation coupling element 213 and the second detachable workstation 220 may comprise a second workstation coupling element 223 provided along the respective bottom surfaces of the first and second planar workstation bases 211, 221, respectively.

In various embodiments, the workstation coupling elements of the first and second detachable workstations 210, 220 (e.g., the first and second workstation coupling elements 213, 223) may embody a sleeve configuration defined by an outer sidewall and an interior channel within which the workspace coupling element is configured to receive at least a portion of a workstation post (e.g., a distal post end thereof opposite the interface post end attached to the crossbar 120) to at least partially attach the corresponding detachable workstation 210, 220 to the respective workstation post.

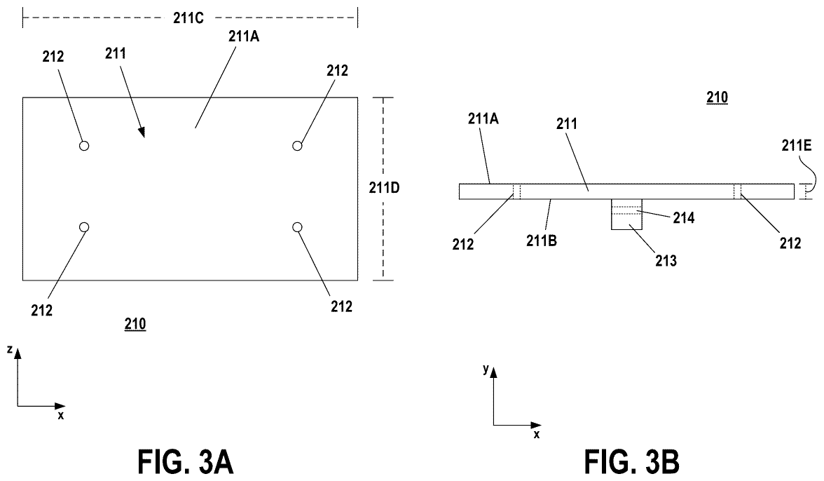

FIGS. 3A and 3B illustrate a top perspective view and a front perspective view, respectively, of a removeable base station of a portable workstation assembly in accordance with an example embodiment described herein. In particular, FIG. 3 illustrates an exemplary detachable workstation of a portable workstation assembly, such as, for example the first detachable workstation 210 of the example portable workstation assembly 10 described herein with respect to FIG. 1. As illustrated in FIG. 3, an exemplary detachable workstation 210 may comprise a planar workstation base 211 defined at least in part by a top base surface 211A and a bottom base surface 211B, with a base thickness 211E defined perpendicularly between the top and bottom base surfaces 211A, 211B along a vertical axis (e.g., in a z-direction, as defined by the example embodiment illustrated in FIG. 3B). As a non-limiting example, in various embodiments, the base thickness 211E defined by the planar workstation base 211 of an example detachable workstation 210 may be at least approximately between 0.10 inches and 0.25 inches (e.g., 0.116 inches).

In various embodiments, the planar workstation base 211 may be configured in an at least substantially square, rectangular, circular, and/or triangular shape, and/or any other shape configured to facilitate the functionality and operability of the detachable workstation 210 as described herein. For example, the example detachable workstation 210 comprises a planar workstation base 211 that is configured in an at least substantially rectangular shape. In such an exemplary configuration, the planar workstation base 211 may be further defined by a base width 211C measured in a lateral direction (e.g., in an x-direction, as defined by the example embodiment illustrated in FIGS. 3A and 3B) between opposing lateral sides of the planar workstation base 211. As a non-limiting example, in various embodiments, the base width 211C defined by the planar workstation base 211 of an example detachable workstation 210 may be at least approximately between 8 inches and 25 inches (e.g., 19 inches).

The planar workstation base 211 may be further defined by a base length 211D measured in a longitudinal direction (e.g., in a y-direction, as defined by the example embodiment illustrated in FIGS. 3A and 3B) between opposing front and rear ends of the planar workstation base 211. As a non-limiting example, in various embodiments, the base length 211D defined by the planar workstation base 211 of an example detachable workstation 210 may be at least approximately between 5 inches and 20 inches (e.g., 12 inches). For example, in such an exemplary configuration, the detachable workstation 210 may be configured such that a surface area of the planar workstation base 211, as defined by the top base surface 211A, may be at least approximately between 45 in² and 500 in² (e.g., 228 in²).

In various embodiments, an exemplary detachable workstation 210 may comprise a plurality of attachment apertures extending through the base thickness of the planar workstation base 211 of the detachable workstation 210 (e.g., in a y-direction as defined in the exemplary orientation of the embodiment illustrated in FIG. 3B) and being configured for receiving one or more of a fastening element and a portion of an external tool or material to facilitate an engagement of the fastening element and the external tool or material that at least partially fastens the external tool or material relative to the planar workstation base 211. In various embodiments, the plurality of attachment apertures 212 of the detachable workstation 210 may be distributed about the planar workstation base 211 in an arrangement configured to facilitate the selective attachment of one or more tools and/or other building materials relative to the planar workstation base 211 by enabling a fastening means by which one or more fastening elements may be provided through respective apertures of the plurality of attachment apertures 212 to engage at least a portion of the one or more tools disposed on the planar workstation base 211 and secure the one or more tools against an adjacent surface of the planar workstation base 211 (e.g., the top base surface 211A and/or the bottom base surface 211B). For example, one or more of the plurality of attachment apertures 212 may be configured to receive at least a portion of one or more tools (e.g., and or the electrical wiring attached thereto) such as, for example, a hand-held powered maintenance tool, a fastening feature defined by large tool, and/or the like, within an outer perimeter of the respective aperture so as to respectively tether, holster, and/or organize the at least one portion of the one or more tools provided therein in a position proximate the planar workstation base 211. In various embodiments, one or more of the distribution, size, shape, and configuration of the plurality of attachment apertures 212 may be configured based on the corresponding configuration of the fastening element and/or fastening portion of the tool that the detachable workstation 210 is configured to receive, support, and/or otherwise secure in an operating position.

For example, the plurality of attachment apertures 212 of the exemplary detachable workstation 210 illustrated in FIGS. 3A and 3B is defined by four attachment apertures arranged in an at least substantially even and/or symmetric distribution about the planar workstation base 211. As a non-limiting example, in various embodiments, the plurality of apertures of an exemplary detachable workstation 210 may be at least approximately between one aperture and 20 apertures (e.g., between four apertures and 8 apertures). In various embodiments, an exemplary detachable workstation 210 may further comprise one or more fastening features (not shown), such as, for example, a hook, ridge, notch, slot and/or the like, disposed about an accessible surface of the planar workstation base 211 such that a corresponding fastening feature secured to one or more external tools and/or apparatuses may be selectively attached to the detachable workstation 210 via a pinned connection, a nut-and-bolt connection, or any other fastening means configured to facilitate an at least temporary fastening of the tool or apparatus to the detachable workstation 210 described herein.

As illustrated in FIG. 3B, in various embodiments, an exemplary detachable workstation 210 may comprise a workstation coupling element 213 having a workstation pin aperture 214 embodied by an at least substantially tubular channel provided along an interior portion that is configured to facilitate a selective fastening of the workstation coupling element 213 to a workstation post to secure the detachable workstation 210 relative to a T-bar frame of the portable workstation assembly. As illustrated, the workstation pin aperture 214 of the workstation coupling element 213 may defined along a central axis thereof that is oriented in a lateral direction at least substantially parallel to the base width 211C of the planar workstation base 211 (e.g., in an x-direction as defined in the example embodiment illustrated in FIG. 3A). In various embodiments, the workstation pin aperture 214 may span a width of the workstation coupling element 213.

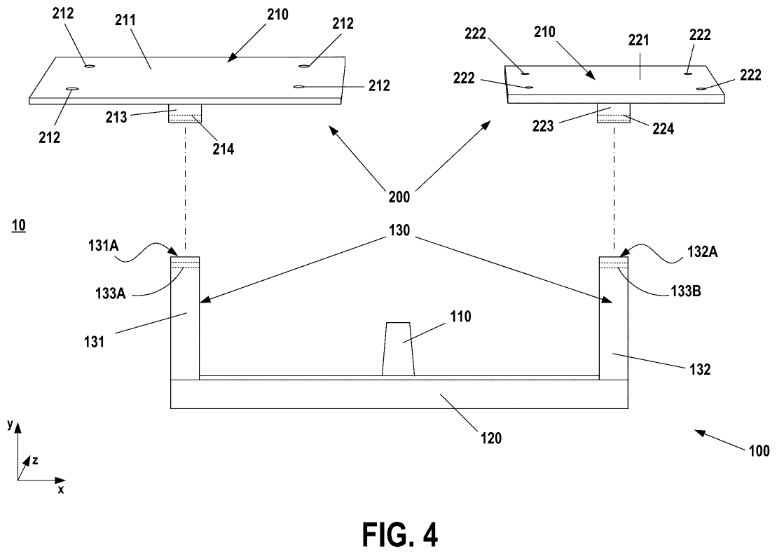

FIG. 4 illustrates an exploded view of a portable workstation assembly in accordance with one or more example embodiments described herein. In various embodiments, the first workstation coupling element 213 may be configured such that securing the first workstation coupling element 213 to a corresponding first workstation post 131 of the plurality 130 defined by the T-bar frame 100 may include aligning the central axes of the first workstation coupling element 213 and the first workstation post 131 in an at least substantially coaxial arrangement and moving the first detachable workstation 210 in a downward vertical direction relative to the first workstation post 131 such that the first workstation coupling element 213 is moved towards the second post end 131B of the first workstation post 131. As a non-limiting example, in various embodiments, attaching the first detachable workstation 210 relative to the T-bar frame 100 may include positioning the first detachable workstation 210 relative to the first workstation post 131 (e.g., on top of the second post end 131B thereof) such that the workstation pin aperture 133A defined by the first workstation past 131 and the first workstation pin aperture 214 defined by the first workstation coupling element 213 of the first detachable workstation 210 are at least partially aligned in an at least substantially coaxial arrangement.

Further, the second workstation coupling element 223 may be configured such that securing the second workstation coupling element 223 to a corresponding second workstation post 132 of the plurality 130 defined by the T-bar frame 100 may include aligning the central axes of the second workstation coupling element 223 and the second workstation post 132 in an at least substantially coaxial arrangement and moving the second detachable workstation 220 in a downward vertical direction relative to the second workstation post 132 such that the second workstation coupling element 223 is moved towards the second post end 132B of the second workstation post 132. As a non-limiting example, in various embodiments, attaching the second detachable workstation 220 relative to the T-bar frame 100 may include positioning the second detachable workstation 220 relative to the second workstation post 132 (e.g., on top of the second post end 132B thereof) such that the second workstation pin aperture 133B defined by the second workstation past 132 and the second workstation pin aperture 224 defined by the second workstation coupling element 213 of the second detachable workstation 220 are at least partially aligned in an at least substantially coaxial arrangement.

For example, the cross-sectional geometry defined by the interior channel of the first workstation coupling element 213 may correspond to that of the first workstation post 131 with which the first detachable workstation 210 is configured to be detachably secured, such that the first workstation post 131 may fit securely within the interior channel of the sleeve defined by the first workstation coupling element 213 to facilitate a secure arrangement of the first detachable workstation 210 relative to the T-bar frame 100. Further, the cross-sectional geometry defined by the interior channel of the second workstation coupling element 223 may correspond to that of the second workstation post 132 with which the second detachable workstation 210 is configured to be detachably secured, such that the second workstation post 132 may fit securely within the interior channel of the sleeve defined by the second workstation coupling element 223 to facilitate a secure arrangement of the second detachable workstation 220 relative to the T-bar frame 100.

As described herein, at least one of the plurality of detachable workstations 200 of an example portable workstation assembly 10 may have one or more characteristics that differs at least in part from a corresponding one or more characteristics of at least one other detachable workstation of the plurality 200 in order to facilitate operability of the at least on detachable workstation in a specific use case that may require a more robust and/or otherwise distinct workspace configuration. For example, in various embodiments the plurality of detachable workstations may comprise a first workstation that is defined by at least one workstation characteristic, such as, for example, one or more of a dimension, a shape, an amount of attachment apertures, a planar workstation base surface area, a planar workstation base thickness and/or the like that is different than the corresponding workstation characteristic defined by the second detachable workstation 220 of the plurality 200.

As a non-limiting example, FIG. 4 illustrates an example portable workstation assembly 10 in which the first detachable workstation 210 of the plurality of detachable workstations 200 is at least substantially larger than the second detachable workstation 220. For example, the surface area defined by the first planar workstation base 211 of the first detachable workstation 210 may be at least substantially larger than the surface area defined by the second planar workstation base 221 of the second detachable workstation 220. Further, the first base thickness defined by the first planar workstation base 211 of the first detachable workstation 210 may be at least substantially smaller than the second base thickness defined by the second planar workstation base 221 of the second detachable workstation 220. As a non-limiting example provided for illustrative purposes, in such an exemplary configuration, the first detachable workstation 210 defined by the larger, thinner planar workstation base may be configured to facilitate the selective fastening of a particular tool (e.g., a relatively bulkier tool), such as, for example, a miter saw, a band saw, and/or the like, to the first planar workstation base 211 thereof to enable an operable portable workstation assembly 10 configuration wherein the miter saw remains attached to the first detachable workstation 210 in a safe and secured position throughout user engagement therewith.

As a non-limiting example provided for illustrative purposes, in such an exemplary configuration, the second detachable workstation 220 of the plurality 200 defined by the smaller, thicker planar workstation base may be configured to facilitate the selective fastening of a particular tool (e.g., a relatively heavier tool), such as, for example, an anvil, a vice, and/or the like, to the second planar workstation base 221 thereof to enable an operable portable workstation assembly 10 configuration wherein the anvil and/or the vice remains attached to the second detachable workstation 220 in a safe and secured position throughout user engagement therewith. In various embodiments, each of the plurality of detachable workstations 200 of the portable workstation assembly 10 may be defined by an at least partially unique configuration (e.g., one or more unique workstation characteristics, as described above) that corresponds to a respective use case, tool, and/or operating condition such that the detachable workstations of the plurality 200 that are secured relative to the plurality of workstation posts 130 of the T-bar frame 100 may be particularly selected and/or interchanged to maximize efficiency, operability, and performance of the portable workstation assembly 10 in a variety of distinct use cases that may be required by a user at various instances over time.

As a non-limiting example provided for illustrative purposes, in the exemplary portable workstation assembly 10 embodiment illustrated in FIG. 4, wherein the second detachable workstation 220 has a planar workstation base 221 that has less surface area and a grater base thickness than those of the first planar workstation base 211 of the first detachable workstation 210, the first planar workstation base 211 may be defined by a surface area of at least approximately 228 in² and a first base thickness of at least approximately 0.1875 inches. Further, the second planar workstation base 221 of the second detachable workstation 220 may be defined by a surface area of at least approximately 60 in² and a second base thickness of at least approximately 0.116 inches.

Although described herein in reference to various example embodiments wherein the example T-bar frames comprise a plurality of workstation posts 130 defined by only two workstation posts (e.g., the first and second workstation posts 131, 132), in various embodiments, an example portable workstation assembly 10 of the present disclosure may comprise a T-bar frame 100 having a plurality of workstation pasts 130 that comprises more than two workstation posts. As a non-limiting example, in various embodiments, the plurality of workstation posts 130 of an exemplary portable workstation assembly 10 may comprise at least approximately between two workstation posts and 10 workstation posts (e.g., between two workstation posts and 4 workstation posts), each configured for receiving and/or engaging a respective one of the plurality of detachable workstations 200 to secure the respective workstation relative to the T-bar frame 100 of the portable workstation assembly 10.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A portable workstation assembly comprising:
a T-bar frame configured for selective attachment relative to an anchor point of a vehicle, the T-bar frame comprising:
an attachment arm;
a crossbar having crossbar length defined along a central axis thereof in between a first crossbar end and a second crossbar end, the crossbar being arranged in an at least substantially perpendicular configuration relative to an arm length defined by an attachment arm central axis of the attachment arm; and
a plurality of workstation posts extending from the crossbar in an at least substantially perpendicular direction relative to the central axis of the crossbar, each of the plurality of workstation posts extending from a first post end disposed at a respective location defined along the crossbar length of the crossbar; and
a plurality of detachable workstations, each of the detachable workstations being configured for selective attachment to a respective workstation post of the plurality of workstation posts defined by the T-bar frame, each of the plurality of detachable workstations comprising:
a planar workstation base;
a plurality of attachment apertures extending through a base thickness of the planar workstation base; and
a workstation coupling element attached to the planar workstation base and configured for engagement with at least a portion of the respective workstation post to facilitate a detachable arrangement of the planar workstation base relative to the respective workstation post.

2. The portable workstation assembly of claim 1, wherein each of the workstation posts define a post length extending along a central axis thereof between the first post end engaged with the crossbar and a second post end, wherein each of the respective workstation posts of the plurality of workstation posts is configured for engagement with one or more of the plurality of detachable workstations at the second post end thereof.

3. The portable workstation assembly of claim 1, wherein each of the respective workstation posts of the plurality of workstation posts is configured such that the respective second post ends of the plurality of workstation posts each engage the one or more detachable workstations at the respective workstation coupling element thereof.

4. The portable workstation assembly of claim 1, wherein each of the workstation coupling elements of the plurality of detachable workstations comprises a workstation pin aperture.

5. The portable workstation assembly of claim 1, wherein the plurality of detachable workstations comprises a first detachable workstation and a second detachable workstation.

6. The portable workstation assembly of claim 5, wherein the first detachable workstation comprises a first planar workstation base defining a first base top surface having a first surface area and the second detachable workstation comprises a second planar workstation base defining a second base top surface having a second surface area, wherein the first surface area is different from the second surface area.

7. The portable workstation assembly of claim 5, wherein the first detachable workstation comprises a first planar workstation base defining a first base thickness and the second detachable workstation comprises a second planar workstation base defining a second base thickness, wherein the first base thickness is different than the second base thickness.

8. The portable workstation assembly of claim 5, wherein each of the plurality of detachable workstations is defined by an at least partially unique configuration wherein one or more workstation characteristic of each detachable workstation is unique relative to the workstation characteristics defined by the other detachable workstations of the plurality of detachable workstations.

9. The portable workstation assembly of claim 5, wherein the plurality of detachable workstations comprises three or more detachable workstations.

10. The portable workstation assembly of claim 1, wherein the plurality of workstation posts of the T-bar frame comprises a first workstation post and a second workstation post.

11. The portable workstation assembly of claim 10, wherein the first workstation post extends from the crossbar at a first location along the crossbar length of the crossbar and the second workstation post extends from the crossbar at a second location along the crossbar length of the crossbar, wherein the first location is at least substantially adjacent the first crossbar end and the second location is at least substantially adjacent the second crossbar end.

12. The portable workstation assembly of claim 10, wherein the plurality of workstation posts comprises three or more workstation posts.

13. The portable workstation assembly of claim 1, wherein each of the plurality of workstation posts are oriented in an at least substantially parallel configuration relative to one another.

14. The portable workstation assembly of claim 13, wherein the plurality of workstation posts are oriented in an at least substantially coplanar configuration.

15. The portable workstation assembly of claim 1, wherein the T-bar frame is configured to attach to the anchor point of the vehicle based at least in part on a fastening element defined at least substantially adjacent a first arm end of the attachment arm.

16. The portable workstation assembly of claim 15, wherein the fastening element is a hitch pin aperture.

17. The portable workstation assembly of claim 1, wherein the plurality of attachment apertures of each of the plurality of detachable workstations comprises at least four attachment apertures distributed about the respective planar workstation bases of each detachable workstation.

18. The portable workstation assembly of claim 17, wherein the plurality of attachment apertures of each of the plurality of detachable workstations is distributed about the respective planar workstation bases of each detachable workstation in a symmetric arrangement.

19. The portable workstation assembly of claim 1, wherein the attachment arm, the crossbar, and the plurality of workstation posts collectively define a unitary configuration such that the T-bar frame is defined by a singular frame component.
